(19) United States
(12) Patent Application Publication
(10) Pub. No.: US 2025/0097296 A1
(43) Pub. Date: Mar. 20, 2025

(54) OPERATIONAL CONTROL SIGNALING IN SUPPORT OF INTEROPERABILITY FUNCTIONALITIES WITH SURVEILLANCE INFRASTRUCTURE

(71) Applicant: QUALCOMM Incorporated, San Diego, CA (US)

(72) Inventors: Mohammed Ali Mohammed Hirzallah, San Diego, CA (US); Rajat Prakash, San Diego, CA (US); Xiaoxia Zhang, San Diego, CA (US)

(21) Appl. No.: 18/469,369

(22) Filed: Sep. 18, 2023

(51) Int. Cl. H04L 67/12; H04N 7/18; H04W 8/00; H04W 60/00

(52) U.S. Cl. CPC H04L 67/12; H04N 7/181; H04W 8/005; H04W 60/00

(57) ABSTRACT

This disclosure provides systems, methods, and devices for wireless communication that provides operational control signaling in support of interoperability functionalities with surveillance infrastructure. In a first aspect, a method of wireless communication includes establishing communication between a network element and one or more multimedia/security/surveillance (MSS) entities using an MSS interface. The network entity may transmit operational control signals to the MSS entities via the MSS interface. The MSS entities may then act on the operational control signals and transmit MSS data to the network element via the MSS interface. Other aspects and features are also claimed and described.

### TECHNICAL FIELD

Aspects of the present disclosure relate generally to wireless communication systems, and more particularly, to interoperability functionality with surveillance infrastructure. Some features may enable and provide improved communications, including operational control signaling in support of interoperability functionalities with surveillance infrastructure.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station or other network entity.

A network entity may transmit data and control information on a downlink to a UE or may receive data and control information on an uplink from the UE. On the downlink, a transmission from the network entity may encounter interference due to transmissions from neighbor network entities or from other wireless radio frequency (RF) transmitters. On the uplink, a transmission from the UE may encounter interference from uplink transmissions of other UEs communicating with the neighbor network entities or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication by a network entity includes establishing communication using a multimedia/security/surveillance (MSS) interface with one or more MSS entities, transmitting operational control signals to the one or more MSS entities via the MSS interface, and receiving MSS data from one or more of the MSS entities via the MSS interface.

In an additional aspect of the disclosure, a method of wireless communication by an MSS entity includes establishing communication using a MSS interface with a network entity, wherein the MSS interface implements an enhanced positioning protocol interface that includes network MSS interface protocol signals received by the MSS entity within enhanced positioning protocol signals, receiving operational control signals from the network entity via the MSS interface, and transmitting MSS data to the network entity via the MSS interface.

In an additional aspect of the disclosure, a network entity includes at least one processor and a memory coupled to the at least one processor. The at least one processor is configured to establish communication using an MSS interface with one or more MSS entities, transmit operational control signals to the one or more MSS entities via the MSS interface, and receive MSS data from one or more of the MSS entities via the MSS interface.

In an additional aspect of the disclosure, an MSS entity includes at least one processor and a memory coupled to the at least one processor. The at least one processor is configured to establish communication using a MSS interface with a network entity,

Qualcomm Ref No. 2306143 3/39 wherein the MSS interface implements an enhanced positioning protocol interface that includes network MSS interface protocol signals received by the MSS entity within enhanced positioning protocol signals, receive operational control signals from the network entity via the MSS interface, and transmit MSS data to the network entity via the MSS interface.

In an additional aspect of the disclosure, an apparatus includes means for establishing communication using an MSS interface with one or more MSS entities, means for transmitting operational control signals to the one or more MSS entities via the MSS interface, and means for receiving MSS data from one or more of the MSS entities via the MSS interface.

In an additional aspect of the disclosure, an apparatus includes means for establishing communication using a MSS interface with a network entity, wherein the MSS interface implements an enhanced positioning protocol interface that includes network MSS interface protocol signals received by the MSS entity within enhanced positioning protocol signals, means for receiving operational control signals from the network entity via the MSS interface and means for transmitting MSS data to the network entity via the MSS interface.

In an additional aspect of the disclosure, a non-transitory computer-readable medium stores instructions that, when executed by a processor, cause the processor to perform operations. The operations include establishing communication using an MSS interface with one or more MSS entities, transmitting operational control signals to the one or more MSS entities via the MSS interface, and receiving MSS data from one or more of the MSS entities via the MSS interface.

In an additional aspect of the disclosure, a non-transitory computer-readable medium stores instructions that, when executed by a processor, cause the processor to perform operations. The operations include establishing communication using a MSS interface with a network entity, wherein the MSS interface implements an enhanced positioning protocol interface that includes network MSS interface protocol signals received by the MSS entity within enhanced positioning protocol signals, receiving operational control signals from the network entity via the MSS interface and transmitting MSS data to the network entity via the MSS interface.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an MSS system.

FIGS. 4A and 4B are flow diagrams illustrating example processes that provide operational control signaling in support of interoperability functionalities with surveillance infrastructure according to one or more aspects.

FIG. 5 is a block diagram illustrating MSS systems and a wireless network, including a network entity, in which the network entity, MSS entities, and MSS server are configured to provide operational control signaling in support of interoperability functionalities with surveillance infrastructure according to one or more aspects.

FIG. 6 is a block diagram illustrating an MSS entity and a wireless network, including a network entity, in which the network entity and MSS entity are configured to provide operational control signaling in support of interoperability functionalities with surveillance infrastructure according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support operational control signaling in support of interoperability functionalities with surveillance infrastructure. Reduced costs and complexity have contributed to the growth of surveillance systems, including various different types of sensors, such as visual cameras, thermographic cameras, ultraviolet cameras, light detection and ranging (Lidar) cameras, which use light in the form of a pulsed laser to measure ranges and variable distances, thermo-sensors, radiation sensors, motion sensors, acoustic sensors, and the like, deployed in an operational network connected using wired or wireless technologies. Additional devices, such as surveillance servers, network video records (NVRs), and the like may further be deployed into the operational network of such surveillance systems to control and record output from the network sensors that include internet protocol (IP) functionality. Collectively, the sensors, servers, and other IP devices of such systems may be referred to as multimedia/security/surveillance (MSS) devices. Furthermore, surveillance systems, security systems, multimedia systems, and the like may be referred to as MSS systems.

Specific protocols and frameworks have been developed to allow interoperability between such MSS entities from different vendors and manufacturers. For example, open network video interface forum (ONVIF) is a network MSS interface protocol is a global open standard that allows interface between MSS entities for security applications. It can also support other functionalities in addition to security, such as device discovery, device management, IP configuration, multimedia configuration, camera control, realtime viewing, event handling, video analytics, and the like. ONVIF hosts other technologies such as simple object access protocol (SOAP), realtime protocol (RTP), and the like, as well as other industry standard video and audio coder/decoding protocols (codecs).

Another example network MSS interface protocol is physical security interoperability alliance (PSIA). Similar to ONVIF, PSIA provides a protocol for interoperability between MSS entities and supports different complementary specifications, including a common security model, common metadata and event model, media device specification, recording and content management specification, NVR and digital video recorder (DVR) support, video analytics specifications, area control specifications, access control and intrusion detection specifications, and the like.

Such PSIA-supported specifications allow security related configuration and management, including a baseline model for adding device-specific information. PSIA-supported features provide interoperability through a common application programming interface (API). MSS entities can send and receive operational controls that handle recording, streaming, managing, and searching of multimedia content over an IP network. Operational controls received via the PSIA API may further support management of video analytics between video management, surveillance, and other MSS entities. Additionally, such operational controls can implement management of access control profiles and intrusion detection profiles. While such network MSS interface protocols (ONVIF, PSIA, etc.) allow MSS entities within an MSS system to communicate with each other to manage, control, and report the functionality of the system or process or view the information detected by the MSS entity sensors, there is generally no standard interface that allows interoperability between MSS entities and other wireless radio access technologies (RATs), such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks.

Particular implementations of the subject matter described in this disclosure may be implemented to realize one or more of the following potential advantages or benefits. In some aspects, the present disclosure provides techniques for a network entity to establish communication using a MSS interface with one or more MSS entities and then transmit operational control signals to the one or more MSS entities via the MSS interface. The network entity may then receive MSS data from one or more of the MSS entities via the MSS interface. On the MSS entity side, the MSS entity may also establish communication using a MSS interface with the network entity, wherein the MSS interface may either implement the network MSS interface protocol compatible with the MSS entity or implement an enhanced positioning protocol interface that includes network MSS interface protocol signals received by the MSS entity within enhanced positioning protocol signals. Once communication with the network entity is established, the MSS entity may receive operational control signals from the network entity via the MSS interface and transmit MSS data to the network entity via the MSS interface.

The MSS data sensed or compiled by the MSS entities may provide valuable information for wireless communication services implemented via the network entity. For example, where the network entity comprises a location server, the MSS data may be used by the location server/network entity to implement location services or radio frequency (RF) sensing. MSS data may further provide information on network or channel conditions for the network entity radio access network (RAN). For example, MSS data may include information on an environmental condition, such as a geographic condition, physical condition, thermal condition, and the like. The network entity may use this information to manage communication parameters for support of communication and other services with users in the wireless network.

Additionally, the MSS data can provide a graphical representation of the environment which can be use in addition to wireless signals to localize and position devices and objects. For example, the network entity can merge or fuse graphical information from MSS data with positioning measurements obtained using measuring signals using a sensor fusion algorithm. The MSS data can also be used to assist positioning services. For example, the network entity may rely on graphical inputs from MSS data to determine line-of-sight (LOS)/non-line-of-sight (NLOS) condition for objects to be positioned and then leverage this condition to determine positioning strategy, including determination of resources and measurements to be conducted for the positioning service. For example, the network entity can conduct image processing on graphical data from the MSS data to determine an obstacle between a transmitter and receiver and, thus, further determine the receiver is in an NLOS condition. The network entity can then determine to use a different transmitter that has an LOS condition with the intended receiver to be positioned.

This disclosure further relates generally to providing or participating in authorized shared access between two or more wireless devices in one or more wireless communications systems, also referred to as wireless communications networks. In various implementations, the techniques and apparatus may be used for wireless communication networks such as CDMA networks, TDMA networks, FDMA networks, OFDMA networks, SC-FDMA networks, LTE networks, GSM networks, 5G or 5G NR networks, as well as other communications networks. As described herein, the terms “networks” and “systems” may be used interchangeably.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

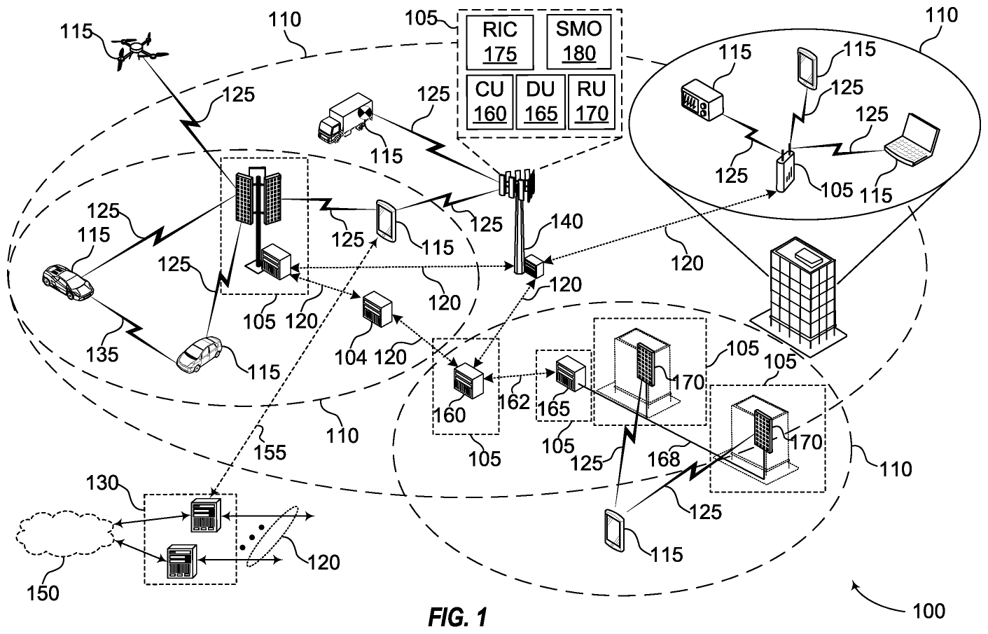

FIG. 1 illustrates an example of a wireless communications system 100 that supports RF component preferences in hybrid beamforming operations at mmWave bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, the network entity 105 may be referred to as a network element, a mobility element, a radio access network (RAN) node, or network equipment, among other nomenclature. In some examples, the network entities 105 and the UEs 115 may wirelessly communicate via one or more communication links 125 (e.g., a radio frequency (RF) access link).

The UEs 115 may be dispersed throughout the coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be the network entity 105 (e.g., any network entity described herein), the UE 115 (e.g., any UE described herein), a network controller, an apparatus, a device, a computing system, one or more components, or another suitable processing entity configured to perform any of the techniques described herein. For example, a node may be the UE 115. As another example, a node may be the network entity 105.

In some examples, the network entities 105 may communicate with the core network 130, or with one another, or both. For example, the network entities 105 may communicate with the core network 130 via one or more backhaul communication links 120 (e.g., in accordance with an S1, N2, N3, or other interface protocol). In some examples, the network entities 105 may communicate with one another over the backhaul communication link 120 (e.g., in accordance with an X2, Xn, or other interface protocol) either directly (e.g., directly between the network entities 105) or indirectly (e.g., via the core network 130). In some examples, the network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, the midhaul communication links 162, or the fronthaul communication links 168 may be or include one or more wired links (e.g., an electrical link, an optical fiber link), one or more wireless links (e.g., a radio link, a wireless optical link), among other examples or various combinations thereof. The UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a transmission-reception point (TRP), a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, the network entity 105 (e.g., the base station 140) may be implemented in an aggregated (e.g., monolithic, standalone) base station architecture, which may be configured to utilize a protocol stack that is physically or logically integrated within a single network entity 105 (e.g., a single RAN node, such as the base station 140).

In some examples, the network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, the network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. The RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The UE 115 may include or may be referred to as a mobile device, a wireless device, a remote device, a handheld device, or a subscriber device, or some other suitable terminology, where the “device” may also be referred to as a unit, a station, a terminal, or a client, among other examples. The UE 115 may also include or may be referred to as a personal electronic device such as a cellular phone, a personal digital assistant (PDA), a tablet computer, a laptop computer, or a personal computer. In some examples, the UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, a satellite radio, a global positioning system (GPS) device, a global navigation satellite system (GNSS) device, a logistics controller, an unmanned aerial vehicle (UAV), a drone, a smart energy or security device, a solar panel or solar array, etc. among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125.

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific one of the UEs 115.

In some examples, the UE 115 may be able to communicate directly with other of the UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of the network entity 105 (e.g., the base station 140, the RU 170), which may support aspects of such D2D communications being configured by or scheduled by the network entity 105. In some examples, one or more UEs 115 in such a group may be outside of the coverage area 110 of the network entity 105 or may be otherwise unable to or not configured to receive transmissions from the network entity 105. In some examples, groups of the UEs 115 communicating via D2D communications may support a one-to-many (1:M) system in which each UE 115 transmits to each of the other ones of the UEs 115 in the group. In some examples, the network entity 105 may facilitate the scheduling of resources for D2D communications. In some other examples, D2D communications may be carried out between the UEs 115 without the involvement of the network entity 105.

In some systems, the D2D communication link 135 may be an example of a communication channel, such as a sidelink communication channel, between vehicles (e.g., the UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., the network entities 105, the base stations 140, the RUs 170) using vehicle-to-network (V2N) communications, or with both.

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between the UE 115 and the network entity 105 or the core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., the communication link 125, the D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

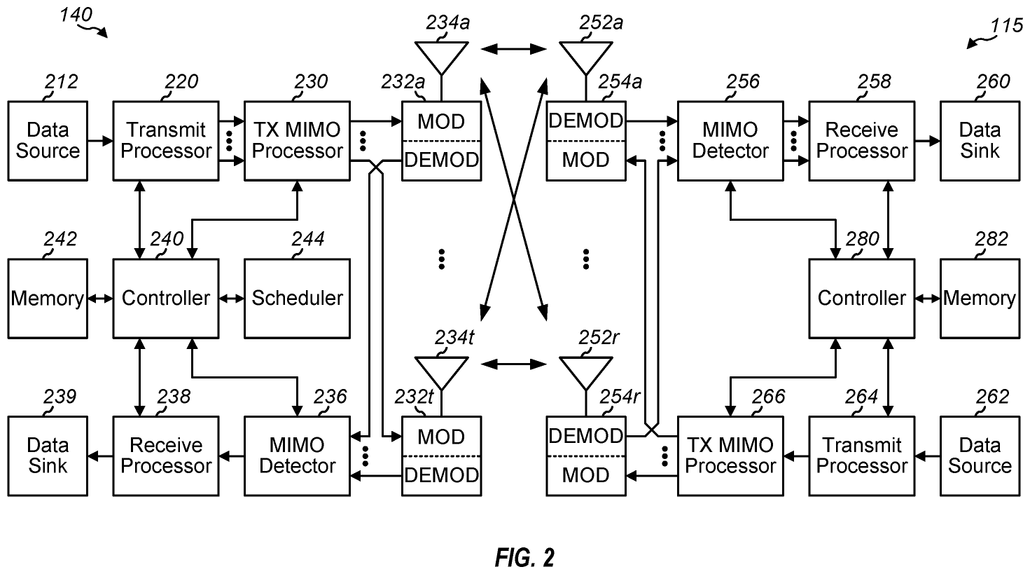

FIG. 2 is a block diagram illustrating examples of the base station 140 and the UE 115 according to one or more aspects. The base station 140 and the UE 115 may be any of the network entities and base stations and one of the UEs in FIG. 1. For a restricted association scenario (as mentioned above), the network entity 105 may be small cell base station, and the UE 115 may be the UE 115 operating in a service area of the small cell base station, which in order to access the small cell base station, would be included in a list of accessible UEs for the small cell base station. The base station 140 may also be a base station of some other type. As shown in FIG. 2, a network entity 105, such as the base station 140 may be equipped with the antennas 234a through 234t, and the UE 115 may be equipped with the antennas 252a through 252r for facilitating wireless communications.

At the base station 140, the transmit processor 220 may receive data from the data source 212 and control information from the controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, the transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. The transmit (TX) MIMO processor 230 may perform spatial processing (e.g., precoding) on the data symbols, the control symbols, or the reference symbols, if applicable, and may provide output symbol streams to the modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from the modulators 232a through 232t may be transmitted via the antennas 234a through 234t, respectively.

At the UE 115, the antennas 252a through 252r may receive the downlink signals from the base station 140 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. The MIMO detector 256 may obtain received symbols from the demodulators 254a through 254r, perform MIMO detection on the received symbols if applicable, and provide detected symbols. The receive processor 258 may process (e.g., demodulate, deinterleave, and decode) the detected symbols, provide decoded data for the UE 115 to the data sink 260, and provide decoded control information to the controller 280, such as a processor.

On the uplink, at the UE 115, the transmit processor 264 may receive and process data (e.g., for a physical uplink shared channel (PUSCH)) from the data source 262 and control information (e.g., for a physical uplink control channel (PUCCH)) from the controller 280. Additionally, the transmit processor 264 may also generate reference symbols for a reference signal. The symbols from the transmit processor 264 may be precoded by the TX MIMO processor 266 if applicable, further processed by the modulators 254a through 254r (e.g., for SC-FDM, etc.), and transmitted to network entity 105. At the network entity 105, the uplink signals from the UE 115 may be received by the antennas 234, processed by the demodulators 232, detected by the MIMO detector 236 if applicable, and further processed by the receive processor 238 to obtain decoded data and control information sent by the UE 115. The receive processor 238 may provide the decoded data to the data sink 239 and the decoded control information to the controller 240.

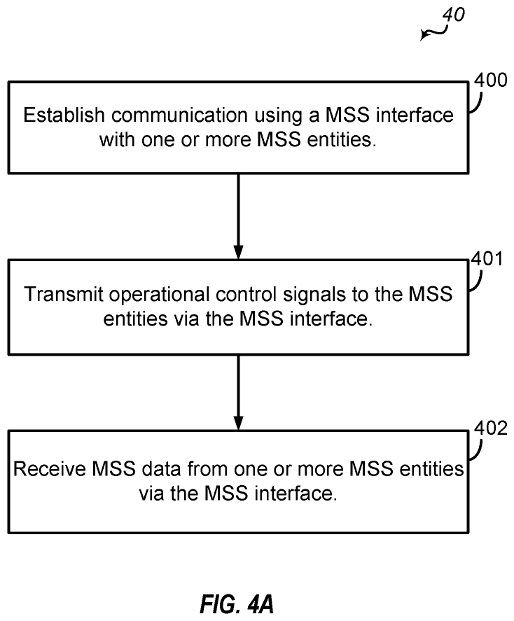

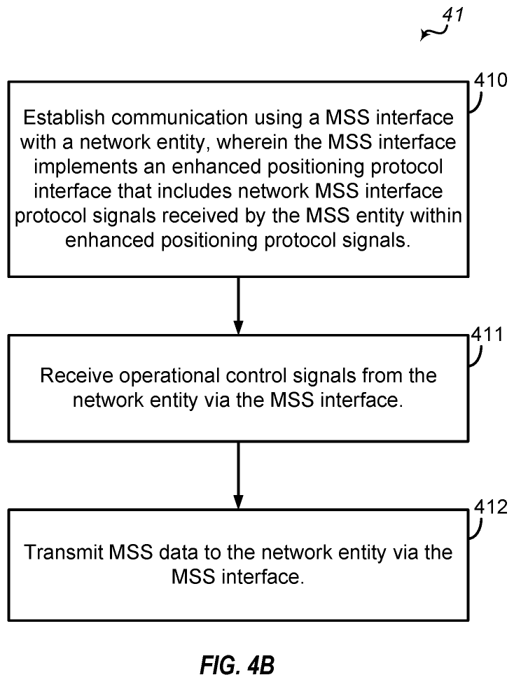

The controllers 240 and 280 may direct the operation at the base station 140 and the UE 115, respectively. The controller 240 or other processors and modules at the base station 140 or the controller 280 or other processors and modules at the UE 115 may perform or direct the execution of various processes for the techniques described herein, such as to perform or direct the execution illustrated in FIGS. 4A and 4B, or other processes for the techniques described herein. The memories 242 and 282 may store data and program codes for the base station 140 and the UE 115, respectively. The scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

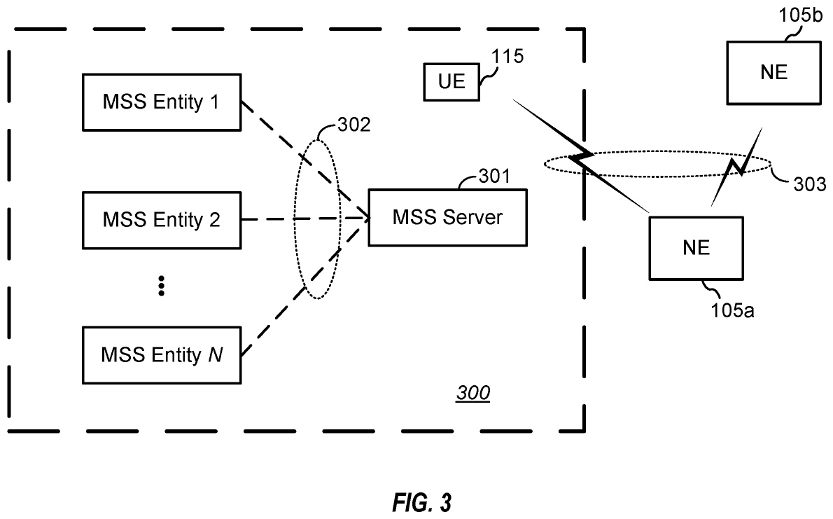

FIG. 3 is a block diagram illustrating an MSS system 300. As noted above, the increased presence of MSS systems, such as MSS system 300, provide frequent availability of MSS data, such as graphical, imagery, and other sensing information. Such MSS data may be useful and leveraged to augment multiple operations within a wireless network, such as enhanced positioning and sensing, channel condition monitoring, and the like. Existing MSS systems, such as MSS system 300, and devices, such as MSS entities 1-N, are generally managed using a proprietary server entity, such as MSS server 301, which communicates with MSS entities 1-N using a network MSS interface protocol 302 (e.g., ONVIF, PSIA, etc.).

A 5G NR network entity, such as network entity 105a, may provide communication and data services to UE 115, located within MSS system 300. When performing location services for the 5G NR network, network entity 105a communicates with other wireless network nodes, such as UE 115 and network entity 105b using a positioning protocol 303. For example, network entity 105a uses an LTE positioning protocol (LPP) to communicate with UE 115 and an NR positioning protocol A (NRPPa) to communicate with network entity 105b. However, current wireless network specifications do not specifically support coordination or interoperability between wireless network devices, such as network entity 105, UE 115 and MSS entities 1-N and MSS system 300. MSS entities 1-N and MSS system 300 are not configured for positioning protocol 303 communications (e.g., LPP, NRPPa, or the like). Moreover, wireless network nodes, such as UE 115 and network entities 105a and 105b, are not configured for network MSS interface protocol 302 communications. Various aspects of the present disclosure provide operational control signaling in support of interoperability functionalities with surveillance infrastructure.

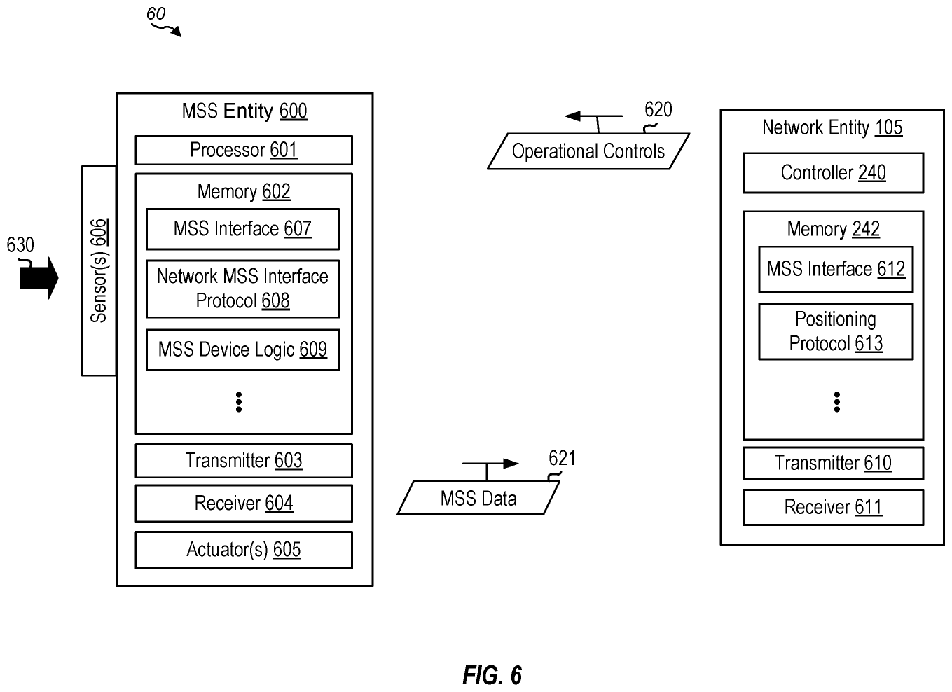

FIG. 4A is a flow diagram illustrating an example process 40 that provides operational control signaling in support of interoperability functionalities with surveillance infrastructure according to one or more aspects. Operations of process 40 may be performed by a network entity, such as network entity 105 described above with reference to FIGS. 1 and 2, or a network entity described with reference to FIG. 6. For example, example operations (also referred to as “blocks”) of process 40 may enable network entity 105 to provide operational control signaling in support of interoperability functionalities with surveillance infrastructure.

At block 400, a network entity establishes communication using a MSS interface with one or more MSS entities. The network entity of a wireless network establishes communication with one or more MSS entities using an MSS interface that allows communication and control information to be exchanged with the MSS entity and MSS systems. In one example aspect, the MSS interface may include network MSS interface protocol signals, compatible with the network MSS interface protocol supported by the MSS entities. In another example aspect, the MSS interface may include an enhanced positioning protocol interface that incorporates network MSS interface protocol signals (e.g., an enhanced LPP, enhanced NRPPa, or the like). The MSS entities may decode the network MSS interface protocol signals incorporated within the enhanced position protocol interface.

At block 401, the network entity transmits operational control signals to the one or more MSS entities via the MSS interface. The network entity can transmit various operation control signals using the MSS interface. As referenced above, in the first example aspect, the network entity would send the operation control signals using the MSS interface to fashion network MSS interface protocol signals compatible with the MSS entity. In the second example aspect, the network entity would wrap the network MSS interface protocol signals within an enhanced positioning protocol.

It should be noted that the operation controls signals may control or manage various aspects of the MSS entity. For example, the operational controls may involve the registration and discovery of the different MSS entities. This may include the network entity broadcasting discovery messages targeting available MSS entities, which the network entity may then register. Operational controls may involve management of reporting by MSS entities from data streaming, configuration of the MSS entity, indicating capabilities of the MSS entities. The network entity may further target such operational controls to predetermined groups of MSS entities.

At block 402, the network entity receives MSS data from one or more of the MSS entities via the MSS interface. Once operation controls have been transmitted to the various MSS entities, the network entity may receive MSS data from one or more of the MSS entities. The network entity may then use that data to manage communications within the wireless network or to provide location services to other network nodes.

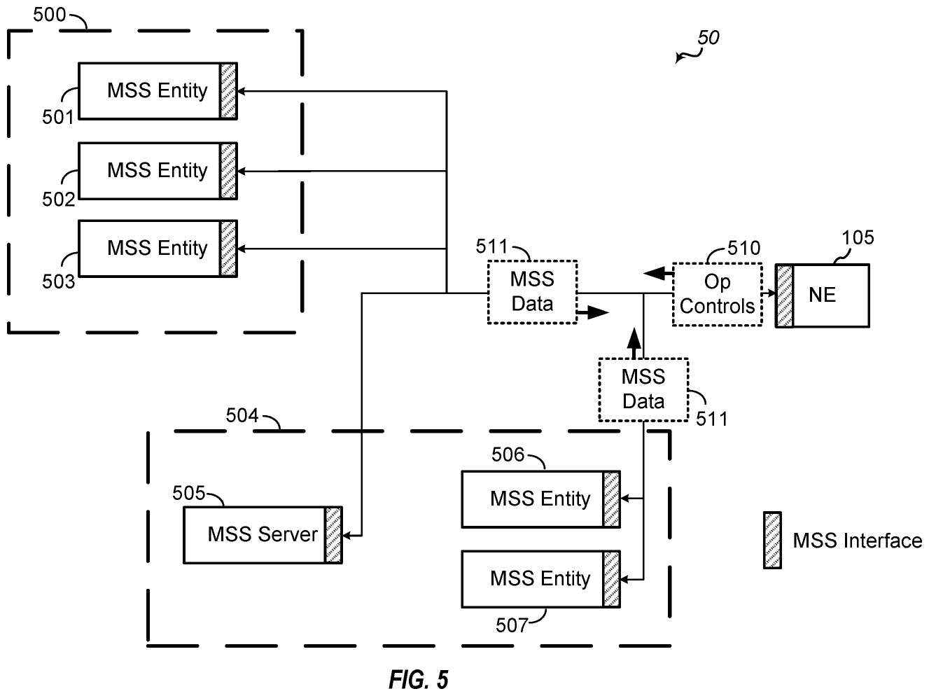

FIG. 4B is a flow diagram illustrating an example process 41 that provides operational control signaling in support of interoperability functionalities with surveillance infrastructure according to one or more aspects. Operations of process 41 may be performed by an MSS entity, such as MSS entity 1-N, 501-503, 506-507, and 600 described above with reference to FIG. 3, or an MSS entity described with reference to FIGS. 5, and 6. For example, example operations (also referred to as “blocks”) of process 41 may enable an MSS entity to recieve operational control signaling in support of interoperability functionalities between a surveillance infrastructure and a wireless network.

At block 410, an MSS entity establishes communication using a MSS interface with a network entity, wherein the MSS interface implements an enhanced positioning protocol interface that includes network MSS interface protocol signals received by the MSS entity within enhanced positioning protocol signals. In the example aspect illustrated at FIG. 4B, the MSS entity establishes communication using the MSS interface that provides the enhanced positioning protocol with network MSS interface protocol signals wrapped in the enhanced position protocol signals.

At block 411, the MSS entity receives operational control signals from the network entity via the MSS interface. As noted above, the operation controls signals from the network entity may control or manage various aspects of the MSS entity. Upon receiving the operational controls, the MSS entity would react according to the control signal.

At block 412, the MSS entity transmits MSS data to the network entity via the MSS interface. The MSS data transmitted by the MSS entity may include image data, video streaming, or other sensing data. It may further include analytics, capabilities of the MSS entities. It may further include an MSS entity-initiated registration process, in which registration signals from the MSS entities are received at the network entity.

As described with reference to FIGS. 4A and 4B, the present disclosure provides techniques for interoperability functionalities with surveillance infrastructure according to one or more aspects. Establishing an interoperability interface between the wireless network and the MSS system allows MSS data to be used at the wireless network level. The MSS data sensed or compiled by the MSS entities may provide valuable information for wireless communication services implemented via the network entity. For example, where the network entity comprises a location server, the MSS data may be used by the location server/network entity to implement location services or RF sensing. MSS data may further provide information on network or channel conditions for the network entity RAN. For example, MSS data may include information on an environmental condition, such as a geographic condition, physical condition, thermal condition, and the like. The network entity may use this information to manage communication parameters for support of communication and other services with users in the wireless network.

FIG. 5 is a block diagram illustrating MSS systems 500 and 504 and wireless network 50, including network entity 105, in which network entity 105, MSS entities 501-503 and 506-507, and MSS server 505 are configured to provide operational control signaling in support of interoperability functionalities with surveillance infrastructure according to one or more aspects. Network entity 105 may include a wireless network entity providing communication to one or more UEs within the coverage area of network entity 105. Network entity 105 may further include a location server, such as a location management function (LMF) server, or a sensing server, such as sensing management function (SnMF) server, providing location or sensing services to other network nodes within its coverage area. Network entity 105 may establish communications with one or more of MSS entities 501-503 of MSS system 500 and one or more of MSS server 505 and MSS entities 506-507 of MSS system 504 using an MSS interface. Network entity 105 supports sending and receiving interoperable functionalities for configuring and signaling with one or more of MSS entities 501-503 of MSS system 500 and one or more of MSS server 505 and MSS entities 506-507 of MSS system 504 using the MSS interface.

In a first optional aspect, the MSS interface may include a positioning protocol-agnostic interface. For example, whether network entity 105 communicates with UEs (not shown) using LPP or other network entities (not shown) using NRPPa, it communicates with one or more of MSS entities 501-503 and 506-507, and MSS server 505 using a network MSS interface protocol. Thus, operational controls 510 are transmitted by network entity 105 using the MSS interface including network MSS interface protocol signals. Similarly, MSS data 511 transmitted by one or more of MSS entities 501-503 and 506-507, and MSS server 505 use network MSS interface protocol signals that network entity 105 may decode using the MSS interface.

In a second optional aspect, the MSS interface may include an enhanced positioning protocol. The enhanced positioning protocol signals encapsulate network MSS interface protocol signals. On receipt of such operational controls 510 using the enhanced position protocol, one or more of MSS entities 501-503 and 506-507, and MSS server 505 may decode the network MSS interface protocol signals within the enhanced positioning protocol message and react according to the control message. Similarly, MSS data 511 transmitted by one or more of MSS entities 501-503 and 506-507, and MSS server 505 use the enhanced positioning protocol to encapsulate the MSS data in network MSS interface protocol signals that network entity 105 may decode using the MSS interface.

In one example aspect, communication may be established between network entity and one or more of MSS entities 501-503 and 506-507, and MSS server 505 using a registration and discovery process. In a first example implementation, network entity 105 initiates discovery by broadcasting a discovery message (operation control 510) using the MSS interface. Any or all of MSS entities 501-503 and 506-507, and MSS server 505 that receive the discovery message may then respond to the broadcast message from network entity 105 with a registration signal (MSS data 511) transmitted using the MSS interface. In a second example implementation, one or more of MSS entities 501-503 and 506-507, and MSS server 505 may initiate registration by transmitting a registration signal (MSS data 511) to network entity 105 using the MSS interface.

FIG. 6 is a block diagram illustrating MSS entity 600 and wireless network 60, including network entity 105, in which network entity 105 and MSS entity 600 are configured to provide operational control signaling in support of interoperability functionalities with surveillance infrastructure according to one or more aspects. Network entity 105 may be configured to perform operations, including the blocks of process 40 described with reference to FIG. 4A. In some implementations, network entity 105 includes the structure, hardware, and components shown and described with reference to network entity 105 and base station 140 of FIGS. 1-2. For example, network entity 105 may include controller 240, which operates to execute logic or computer instructions stored in memory 242, as well as controlling the components of network entity 105 that provide the features and functionality of network entity 105. Network entity 105, under control of controller 240, transmits and receives signals via transmitter 610 and receiver 611, respectively. Transmitter 610 and receiver 611 include various components and hardware, as illustrated in FIG. 2 for base station 140, including modulator and demodulators 232a-t, transmit processor 220, TX MIMO processor 230, MIMO detector 236, and receive processor 238.

As shown, the memory 242 may include MSS interface 612, positioning protocol 613, and the like. MSS interface 612 includes the code and logic, which, when executed by controller 240 (referred to herein as the “execution environment” of MSS interface 612), provides the features and functionalities described herein to implement the MSS interface, providing interoperability functionalities between network entity 105 and one or more MSS entities. Positioning protocol 611 includes the code and logic, which, when executed by controller 240, implements positioning and location services communications with one or more UEs or other network entities. Positioning protocol 611 may include LPP for network entity 105 to exchange positioning and location services communications with UEs and may include NRPPa for network entity 105 to exchange positioning and location services communications with other network entities. Network entity 105 may receive signals from or transmit signals to one or more MSS entities, such as MSS entities 1-N and MSS server 301 of FIG. 3, MSS entities 501-503, 506, and 507 and MSS server 505 of FIG. 5, and MSS entity 600 of FIG. 6.

In some implementations, MSS entity 600 may include processor 601, memory 602, transmitter 603, receiver 604, actuator(s) 605, and sensor(s) 606. Processor 601 executes instructions of code and logic stored in memory 602 providing the features and functionality of MSS entity 600. Processor 601 may further control additional elements of MSS entity 600, including transmitter 603, for transmitting control and data signals, receiver 604, for receiving control and data signals, actuator(s) 605, which may include hardware elements, such as actuators, gears, servos, and the like, to apply control to the device of MSS entity 600. For example, when MSS entity 600 is implemented as a type of camera, actuator(s) 605 may control pan, tilt, zoom, roll, focus, etc. When MSS entity 600 is implemented as a part of an access control systems, actuator(s) 605 may control locking and unlocking of an entryway or door. Sensor(s) 606 may include the various multiple sensors available on MSS entity 600, such as image sensors, thermographic sensors, light sensors, motion sensors, and the like. Sensor(s) 606 detect external input 630 for which MSS entity 600 may process and provide MSS data via transmitter 603, such as transmitting streaming audiovisual data, visual data, thermograph/lidar data, analytics of such detected external input 630, and the like.

As shown, memory 602 may include MSS interface 607, network MSS interface protocol 608, and MSS device logic 609. MSS interface 607 includes the code and logic, which, when executed by processor 607, provides the features and functionalities described herein to implement the MSS interface, providing interoperability functionalities between MSS entity 600 and network entity 105. Network MSS interface protocol 608 includes the code and logic, which, when executed by processor 607, implements MSS system control and data communications amount one or more MSS entities of any particular MSS system. Network MSS interface protocol 608 may include one or more existing protocols, such as ONVIF, PSIA, and the like.

As noted above, a first optional aspect allows network entity 105 to transmit operational controls 620 to MSS entity 600 using MSS interface 612, which includes a positioning protocol-agnostic interface. In such optional aspect, MSS interface 612 facilitates network entity 105 to transmit operational controls 620 via transmitter 610 using a network MSS interface protocol. MSS entity 600 receives operational controls 620 via receiver 604 and, within the execution environment of MSS interface 607 and network MSS interface protocol, decodes the operational signals from network entity 105. MSS entity 600 may then, within the execution environment of MSS device logic 609, implement the operational signal from network entity 105, which may include using actuator(s) 605 to manipulate the position or exposure of sensor(s) 606 for capturing or processing of external input 630.

The operational signal from network entity 105 may further include handling and reporting of external input 630 as sensed and processed by MSS entity via sensor(s) 606, and within the execution environment of MSS device logic 609. MSS entity 600, within the execution environment of network MSS interface protocol 609 and MSS interface 607, transmits MSS data 621 to network entity 105 using transmitter 603. According to the first optional aspect, MSS entity 600 transmits MSS data 621 using a network MSS interface protocol. Network entity 105 receives MSS data 621 via receiver 614 and, within the execution environment of MSS interface 612 decodes the MSS data from MSS entity 600.

In the second optional aspect, network entity 105 transmits operational controls 620 to MSS entity 600 using MSS interface 612, which includes an enhanced positioning protocol. MSS interface 612, according to the second optional aspect, encapsulates network MSS interface protocol signals within a positioning protocol provided within the execution environment of positioning protocol 613. MSS entity 600 receives operational controls 620 via receiver 604. Within the execution environment of MSS interface 607 and network MSS interface protocol 608, MSS entity 600 decodes the operational signals having the network MSS interface protocol encapsulated with the positioning protocol. MSS entity 600 may again, within the execution environment of MSS device logic 609, implement the operational signal from network entity 105. MSS entity 600, within the execution environment of network MSS interface protocol 609 and MSS interface 607, may then transmit MSS data 621 to network entity 105 using transmitter 603. According to the second optional aspect, MSS entity 600 transmits MSS data 621 using a positioning protocol in which the data includes a network MSS interface protocol encapsulated within the positioning protocol. Network entity 105 receives MSS data 621 via receiver 614 and, within the execution environment of MSS interface 612 and positioning protocol 613, decodes the MSS data from MSS entity 600.

MSS interface 607 and 612 may be configured to include the ability for network entity 105 to configure various different device features or functionalities of MSS entity 600. For example, operational controls 620 may include configuration signals for MSS entity related to reporting aspects for communication or streaming of MSS data. Such reporting aspects may include reporting periodicity, reporting condition (e.g., events, conditions, etc.), reporting storage locations, and the like.

MSS interface 607 and 612 may further be configured to include the ability for network entity 105 to configure a group of MSS entities. Referring back to FIG. 5, network entity 105 may desire to configure the MSS entities of MSS system 504. Network entity 105, within the execution environment of MSS interface 612 may broadcast operational controls 620 for configuration of MSS entities 506 and 507 and MSS server 505. The grouping of MSS entities for broadcast signaling may further be based on a geographical region, a group of MSS entities that support certain capabilities, MSS entities of a given manufacturer, of a given model, or the like.

It should be noted that where MSS entities are 3GPP-enabled, such broadcast operational controls may be provided as a party of a positional system information block (PosSIB) transmission.

Various aspects of the present disclosure may provide for MSS interface 607 and 612 to enable network entity 105 to configure MSS entity 600 with network settings, firmware settings, system restore settings, security parameters/policy settings, storage settings, and the like. Network entity 105 may further configure MSS entity 600 with regard to event handling and notification, live media streaming protocols, transport format, media transport (RTP, RTCP), synchronization points, .ive media control protocols (e.g., RTSP, secure RTSPS), live media back channel and multicasting streaming, playback, export file format, and the like. Network entity 105 may further provide MSS entity 600 configurations on access control (e.g., access point info, area info, access point status), access rules (e.g., access profile info), action engine (e.g., e-mail, HTTP post, FTP, etc.), supported analytics (e.g., frame temporal/spatial relations, objects [tree, descriptor, shape, color, motion, vehicle info, license plate info, face descriptor, human shape descriptor]), application management (e.g., install, uninstall, updater upgrade, backup, etc.), authentication behavior (e.g., authentication profile, security level info, etc.), credentials (e.g., credential info and setting—get/set/modify), device input/output (I/O) (e.g., video/audio, analog/digital, relay), display setting (e.g., setting display options), door control options (e.g., door info/door status/door control—lock and unlock), image settings (e.g., setting of imaging, focus and zoom, image events—blur/dark/bright/loss, motion alarm, thermal imaging setting), media settings (e.g., audio/video codecs and I/O configurations, media profile configurations—source/destination/encoding, meta data configurations, on-screen displace configurations, streaming uniform resource indicator (URI)), provisioning and pan-tilt-zoom (PTZ) (e.g., pan, tilt, zoom, roll, focus, stop, etc.), recording and replay control and search (e.g., create, get, set, delete, search, and replay recording), resource queries (e.g., address, authentication), schedule settings (e.g., set of time periods and events), security settings, and the like.

It should be noted that, while numerous examples are provided here for the different types of configuration information that MSS interface 607 and 612 may facilitate, the various aspects of the present disclosure are not limited to any particular set of configuration features.

It should further be noted that 3GPP-enabled MSS entities may receive such configurations via the MSS interface as a part of LPP assistance data exchange.

MSS interface 607 and 612 may further be configured to include the ability for network entity 105 and MSS entity 600 to exchange capabilities information. For example, operational controls 620 may include a request for capabilities of MSS entity 600, to which MSS entity 600 sends such capabilities information to network entity 105 in MSS data 621. Alternatively, MSS entity 600 may initiate transmission of such capabilities information in MSS data 621. Capabilities included in which capabilities information may include support in terms of system information and retrieval, network information, firmware information, system restore capabilities, security parameters/policy capabilities, storage capabilities. Capabilities may further include support of event handling and notification management, geolocation information capabilities, supported live media streaming protocols along with available transport formats, media transport (RTP, RTCP), synchronization points, live media control protocols and aspects (e.g., RTSP, secure RTSPS), live media back channel and multicasting streaming aspects, playback options and aspects, export file format specifications, access control (e.g., access point info, area info, access point status), access rules (e.g., access profile info), supported action engines (e.g., e-mail, HTTP post, FTP, etc.), supported analytics (e.g., frame temporal/spatial relations, objects [tree, descriptor, shape, color, motion, vehicle info, license plate info, face descriptor, human shape descriptor]), supported application management (e.g., install, uninstall, updater upgrade, backup, etc.), supported authentication behaviors (e.g., authentication profile, security level info, etc.), supported credentials (e.g., credential info and setting—get/set/modify), supported device I/O (e.g., video/audio, analog/digital, relay), supported display options, supported door control options (e.g., door info/door status/door control—lock & unlock), supported imaging options (e.g., setting of imaging, focus and zoom, image events—blur/dark/bright/loss, motion alarm, thermal imaging setting), supported media (e.g., audio/video codecs and I/O configurations, media profile configurations—source/destination/encoding, meta data configurations, on-screen displace configurations, streaming URI), supported provisioning and PTZ features (e.g., pan, tilt, zoom, roll, focus, stop), supported recording and replay control and search features (e.g., create, get, set, delete, search, and replay recording), supported resource query features (e.g., address, authentication), supported schedule features (e.g., set of time periods and events), supported security configurations, and the like.

It should be noted that, while numerous examples are provided here for the different types of capabilities information that MSS interface 607 and 612 may facilitate, the various aspects of the present disclosure are not limited to any particular set of capabilities for reporting.

It should further be noted that 3GPP-enabled MSS entities may receive such configurations via the MSS interface as a part of LPP capability exchange.

MSS interface 607 and 612 may further be configured to include the ability for network entity 105 and MSS entity 600 to control and reference web services, profile setting, IP configurations, device discovery, device management, capability information, system information and retrieval, network information, firmware upgrades, system restore features, security parameters/policy setting, storage configurations, event handling and notification management, geolocation information exchange and the like. MSS interface 607 and 612, thus, may be configured to allow far reaching interoperability between 3GPP networks, including network 105, and MSS systems, including MSS entity 600.

It is noted that one or more blocks (or operations) described with reference to FIGS. 4A and 4B may be combined with one or more blocks (or operations) described with reference to another of the figures. For example, one or more blocks (or operations) of FIG. 4A may be combined with one or more blocks (or operations) of FIG. 5. As another example, one or more blocks associated with FIG. 4B may be combined with one or more blocks associated with FIG. 6. As another example, one or more blocks associated with FIGS. 4A and 4B may be combined with one or more blocks (or operations) associated with FIGS. 1-3.

In one or more aspects, techniques for supporting operational control signaling in support of interoperability functionalities with surveillance infrastructure may include additional aspects, such as any single aspect or any combination of aspects described below or in connection with one or more other processes or devices described elsewhere herein. A first aspect, supporting operational control signaling in support of interoperability functionalities with surveillance infrastructure, may include a method for wireless communication by a network entity that includes establishing communication using a MSS interface with one or more MSS entities, transmitting operational control signals to the one or more MSS entities via the MSS interface, and receiving MSS data from one or more of the MSS entities via the MSS interface.

Additionally, a network entity may perform or operate according to one or more aspects as described below. In some implementations, the network entity includes a wireless device, such as a base station or location server. In some implementations, the network entity may include at least one processor, and a memory coupled to the processor. The processor may be configured to perform operations described herein with respect to the apparatus. In some other implementations, the network entity may include a non-transitory computer-readable medium having program code recorded thereon and the program code may be executable by a computer for causing the computer to perform operations described herein with reference to the apparatus. In some implementations, the network entity may include one or more means configured to perform operations described herein. In some implementations, a method of wireless communication may include one or more operations described herein with reference to the network entity.

In a second aspect, alone or in combination with the first aspect, wherein the MSS interface includes one of a network MSS interface that includes network MSS interface protocol signals that the network entity transmits directly to the one or more MSS entities; or an enhanced positioning protocol interface that includes network MSS interface protocol signals that the network entity transmits to the one or more MSS entities within enhanced positioning protocol signals.

In a third aspect, alone or in combination with one or more of the first aspect or the second aspect, wherein the establishing the communication includes: transmitting a discovery broadcast message using the MSS interface; and receiving a registration signal from the one or more MSS entities.

In a fourth aspect, alone or in combination with one or more of the first aspect through the third aspect, wherein the establishing the communication includes: receiving a registration request from the one or more MSS entities; and transmitting a registration signal to the one or more MSS entities in response to the registration request.

In a fifth aspect, alone or in combination with one or more of the first aspect through the fourth aspect, wherein the operational control signals include MSS entity configuration signals configuring a functional operation of the one or more MSS entities.

In a sixth aspect, alone or in combination with one or more of the first aspect through the fifth aspect, wherein the MSS entity configuration signals includes reporting parameters that configure a reporting operation of the one or more MSS entities to the network entity.

In a seventh aspect, alone or in combination with one or more of the first aspect through the sixth aspect, wherein the transmitting the operational control signals includes: identifying a target group of MSS entities from the one or more MSS entities, wherein the target group of MSS entities includes each MSS entity of the one or more MSS entities satisfying a predefined criteria; and broadcasting the operational control signals to the target group of MSS entities via the MSS interface.

In an eighth aspect, alone or in combination with one or more of the first aspect through the seventh aspect, wherein the MSS data includes capability data of a corresponding MSS entity of the one or more MSS entities from which the MSS data is received.

A ninth aspect may include a network entity comprising a memory storing processor-readable code and at least one processor coupled to the memory, where the at least one processor configured to execute the processor-readable code to cause the at least one processor to: establish communication using a multimedia/security/surveillance (MSS) interface with one or more MSS entities; transmit operational control signals to the one or more MSS entities via the MSS interface; and receive MSS data from one or more of the MSS entities via the MSS interface.

In a tenth aspect, alone or in combination with the ninth aspect, wherein the MSS interface includes one of: a network MSS interface that includes network MSS interface protocol signals that the network entity transmits directly to the one or more MSS entities; or an enhanced positioning protocol interface that includes network MSS interface protocol signals that the network entity transmits to the one or more MSS entities within enhanced positioning protocol signals.

In an eleventh aspect, alone or in combination with one or more of the ninth aspect and the tenth aspect, wherein the configuration of the at least one processor to establish the communication includes configuration of the at least one processor to: transmit a discovery broadcast message using the MSS interface; and receive a registration signal from the one or more MSS entities.

In a twelfth aspect, alone or in combination with one or more of the ninth aspect through the eleventh aspect, wherein the configuration of the at least one processor to establish the communication includes configuration of the at least one processor to: receive a registration request from the one or more MSS entities; and transmit a registration signal to the one or more MSS entities in response to the registration request.

In a thirteenth aspect, alone or in combination with one or more of the ninth aspect through the twelfth aspect, wherein the operational control signals include MSS entity configuration signals configuring a functional operation of the one or more MSS entities.

In a fourteenth aspect, alone or in combination with one or more of the ninth aspect through the thirteenth aspect, wherein the MSS entity configuration signals includes reporting parameters that configure a reporting operation of the one or more MSS entities to the network entity.

In a fifteenth aspect, alone or in combination with one or more of the ninth aspect through the fourteenth aspect, wherein the configuration of the at least one processor to transmit the operational control signals includes configuration of the at least one processor to: identify a target group of MSS entities from the one or more MSS entities, wherein the target group of MSS entities includes each MSS entity of the one or more MSS entities satisfying a predefined criteria; and broadcast the operational control signals to the target group of MSS entities via the MSS interface.

In a sixteenth aspect, alone or in combination with one or more of the ninth aspect through the fifteenth aspect, wherein the MSS data includes capability data of a corresponding MSS entity of the one or more MSS entities from which the MSS data is received.

A seventeenth aspect may include a network entity configured for wireless communication, where the network entity comprises means for establishing communication using a MSS interface with one or more MSS entities; means for transmitting operational control signals to the one or more MSS entities via the MSS interface; and means for receiving MSS data from one or more of the MSS entities via the MSS interface.

In an eighteenth aspect, alone or in combination with the seventeenth aspect, wherein the MSS interface includes one of: a network MSS interface that includes network MSS interface protocol signals that the network entity transmits directly to the one or more MSS entities; or an enhanced positioning protocol interface that includes network MSS interface protocol signals that the network entity transmits to the one or more MSS entities within enhanced positioning protocol signals.

In a nineteenth aspect, alone or in combination with one or more of the seventeenth aspect and the eighteenth aspect, wherein the means for establishing the communication includes: means for transmitting a discovery broadcast message using the MSS interface; and means for receiving a registration signal from the one or more MSS entities.

In a twentieth aspect, alone or in combination with one or more of the seventeenth aspect through the nineteenth aspect, wherein the means for establishing the communication includes: means for receiving a registration request from the one or more MSS entities; and means for transmitting a registration signal to the one or more MSS entities in response to the registration request.

In a twenty-first aspect, alone or in combination with one or more of the seventeenth aspect through the twentieth aspect, wherein the operational control signals include MSS entity configuration signals configuring a functional operation of the one or more MSS entities.

In a twenty-second aspect, alone or in combination with one or more of the seventeenth aspect through the twenty-first aspect, wherein the MSS entity configuration signals includes reporting parameters that configure a reporting operation of the one or more MSS entities to the network entity.

In a twenty-third aspect, alone or in combination with one or more of the seventeenth aspect through the twenty-second aspect, wherein the means for transmitting the operational control signals includes: means for identifying a target group of MSS entities from the one or more MSS entities, wherein the target group of MSS entities includes each MSS entity of the one or more MSS entities satisfying a predefined criteria; and means for broadcasting the operational control signals to the target group of MSS entities via the MSS interface.

In a twenty-fourth aspect, alone or in combination with one or more of the seventeenth aspect through the twenty-third aspect, wherein the MSS data includes capability data of a corresponding MSS entity of the one or more MSS entities from which the MSS data is received.

A twenty-fifth aspect may include a non-transitory computer-readable medium storing instructions that, when executed by a processor of a network entity, cause the processor to perform operations comprising establishing communication using a MSS interface with one or more MSS entities; transmitting operational control signals to the one or more MSS entities via the MSS interface; and receiving MSS data from one or more of the MSS entities via the MSS interface.

In a twenty-sixth aspect, alone or in combination with the twenty-fifth aspect, wherein the MSS interface includes one of: a network MSS interface that includes network MSS interface protocol signals that the network entity transmits directly to the one or more MSS entities; or an enhanced positioning protocol interface that includes network MSS interface protocol signals that the network entity transmits to the one or more MSS entities within enhanced positioning protocol signals.

In a twenty-seventh aspect, alone or in combination with the twenty-fifth aspect and the twenty-sixth aspect, wherein the instructions to cause the processor to perform establishing the communication includes instructions to cause the processor to perform: transmitting a discovery broadcast message using the MSS interface; and receiving a registration signal from the one or more MSS entities.

In a twenty-eighth aspect, alone or in combination with the twenty-fifth aspect through the twenty-seventh aspect, wherein the instructions to cause the processor to perform establishing the communication includes instructions to cause the processor to perform: receiving a registration request from the one or more MSS entities; and transmitting a registration signal to the one or more MSS entities in response to the registration request.

In a twenty-ninth aspect, alone or in combination with the twenty-fifth aspect through the twenty-eighth aspect, wherein the operational control signals include MSS entity configuration signals configuring a functional operation of the one or more MSS entities.

In a thirtieth aspect, alone or in combination with the twenty-fifth aspect through the twenty-ninth aspect, wherein the MSS entity configuration signals includes reporting parameters that configure a reporting operation of the one or more MSS entities to the network entity.

In a thirty-first aspect, alone or in combination with the twenty-fifth aspect through the thirtieth aspect, wherein the instructions to cause the processor to perform transmitting the operational control signals includes instructions to cause the processor to perform: identifying a target group of MSS entities from the one or more MSS entities, wherein the target group of MSS entities includes each MSS entity of the one or more MSS entities satisfying a predefined criteria; and broadcasting the operational control signals to the target group of MSS entities via the MSS interface.

In a thirty-second aspect, alone or in combination with the twenty-fifth aspect through the thirty-first aspect, wherein the MSS data includes capability data of a corresponding MSS entity of the one or more MSS entities from which the MSS data is received.

In one or more aspects, techniques for supporting operational control signaling in support of interoperability functionalities with surveillance infrastructure may include additional aspects, such as any single aspect or any combination of aspects described below or in connection with one or more other processes or devices described elsewhere herein. In a thirty-third aspect, supporting operational control signaling in support of interoperability functionalities with surveillance infrastructure may include a method operable by an MSS entity that includes establishing communication using a MSS interface with a network entity, wherein the MSS interface implements an enhanced positioning protocol interface that includes network MSS interface protocol signals received by the MSS entity within enhanced positioning protocol signals, receiving operational control signals from the network entity via the MSS interface, and transmitting MSS data to the network entity via the MSS interface.

Additionally, the MSS entity may perform or operate according to one or more aspects as described below. In some implementations, the MSS entity may include at least one processor, and a memory coupled to the processor. The processor may be configured to perform operations described herein with respect to the MSS entity. In some other implementations, the MSS entity may include a non-transitory computer-readable medium having program code recorded thereon and the program code may be executable by a computer for causing the computer to perform operations described herein with reference to the MSS entity. In some implementations, the MSS entity may include one or more means configured to perform operations described herein. In some implementations, a method of wireless communication may include one or more operations described herein with reference to the MSS entity.

In a thirty-fourth aspect, alone or in combination with the thirty-third aspect, wherein the establishing the communication includes: receiving a discovery broadcast message from the network entity via the MSS interface; and transmitting a registration signal to the network entity in response to the discovery broadcast message.

In a thirty-fifth aspect, alone or in combination with one or more of the thirty-third aspect and the thirty-fourth aspect, wherein the establishing the communication includes: transmitting a registration request to the network entity; and receiving a registration signal from the network entity.

In a thirty-sixth aspect, alone or in combination with one or more of the thirty-third aspect through the thirty-fifth aspect, wherein the operational control signals include MSS entity configuration signals configuring a functional operation of the MSS entity.

In a thirty-seventh aspect, alone or in combination with one or more of the thirty-third aspect through the thirty-sixth aspect, wherein the MSS entity configuration signals includes reporting parameters that configure a reporting operation of the MSS entity to the network entity.

In a thirty-eighth aspect, alone or in combination with one or more of the thirty-third aspect through the thirty-seventh aspect, wherein the MSS data includes capability data of the MSS entity.

A thirty-ninth aspect may include an MSS entity that includes a memory storing processor-readable code; and at least one processor coupled to the memory, the at least one processor configured to execute the processor-readable code to cause the at least one processor to establish communication using a MSS interface with a network entity, wherein the MSS interface implements an enhanced positioning protocol interface that includes network MSS interface protocol signals received by the MSS entity within enhanced positioning protocol signals; to receive operational control signals from the network entity via the MSS interface; and to transmit MSS data to the network entity via the MSS interface.

In a fortieth aspect, alone or in combination with the thirty-ninth aspect, wherein the configuration of the at least one processor to establish the communication includes configuration of the at least one processor to: receive a discovery broadcast message from the network entity via the MSS interface; and transmit a registration signal to the network entity in response to the discovery broadcast message.

In a forty-first aspect, alone or in combination with one or more of the thirty-ninth aspect and the fortieth aspect, wherein the configuration of the at least one processor to establish the communication includes configuration of the at least one processor to: transmit a registration request to the network entity; and receive a registration signal from the network entity.

In a forty-second aspect, alone or in combination with one or more of the thirty-ninth aspect through the forty-first aspect, wherein the operational control signals include MSS entity configuration signals configuring a functional operation of the MSS entity.

In a forty-third aspect, alone or in combination with one or more of the thirty-ninth aspect through the forty-second aspect, wherein the MSS entity configuration signals includes reporting parameters that configure a reporting operation of the MSS entity to the network entity.

In a forty-fourth aspect, alone or in combination with one or more of the thirty-ninth aspect through the forty-third aspect, wherein the MSS data includes capability data of the MSS entity.

A forty-fifth aspect may include an MSS entity configured for wireless communication, the MSS entity comprising means for establishing communication using a MSS interface with a network entity, wherein the MSS interface implements an enhanced positioning protocol interface that includes network MSS interface protocol signals received by the MSS entity within enhanced positioning protocol signals; means for receiving operational control signals from the network entity via the MSS interface; and means for transmitting MSS data to the network entity via the MSS interface.

In a forty-sixth aspect, alone or in combination with the forty-fifth aspect, wherein the means for establishing the communication includes: means for receiving a discovery broadcast message from the network entity via the MSS interface; and means for transmitting a registration signal to the network entity in response to the discovery broadcast message.

In a forty-seventh aspect, alone or in combination with one or more of the forty-fifth aspect and the forty-sixth aspect, wherein the means for establishing the communication includes: means for transmitting a registration request to the network entity; and means for receiving a registration signal from the network entity.

In a forty-eighth aspect, alone or in combination with one or more of the forty-fifth aspect through the forty-seventh aspect, wherein the operational control signals include MSS entity configuration signals configuring a functional operation of the MSS entity.

In a forty-ninth aspect, alone or in combination with one or more of the forty-fifth aspect through the forty-eighth aspect, wherein the MSS entity configuration signals includes reporting parameters that configure a reporting operation of the MSS entity to the network entity.

In a fiftieth aspect, alone or in combination with one or more of the forty-fifth aspect through the forty-ninth aspect, wherein the MSS data includes capability data of the MSS entity.

A fifty-first aspect may include a non-transitory computer-readable medium storing instructions that, when executed by a processor of an MSS entity, cause the processor to perform operations comprising establishing communication using a MSS interface with a network entity, wherein the MSS interface implements an enhanced positioning protocol interface that includes network MSS interface protocol signals received by the MSS entity within enhanced positioning protocol signals; receiving operational control signals from the network entity via the MSS interface; and transmitting MSS data to the network entity via the MSS interface.

In a fifty-second aspect, alone or in combination with the fifty-first aspect, wherein the instructions to cause the processor to perform establishing the communication includes instructions to cause the processor to perform: receiving a discovery broadcast message from the network entity via the MSS interface; and transmitting a registration signal to the network entity in response to the discovery broadcast message.

In a fifty-third aspect, alone or in combination with the fifty-first aspect and the fifty-second aspect, wherein the instructions to cause the processor to perform establishing the communication includes instructions to cause the processor to perform: transmitting a registration request to the network entity; and receiving a registration signal from the network entity.

In a fifty-fourth aspect, alone or in combination with one or more of the fifty-first aspect through the fifty-third aspect, wherein the operational control signals include MSS entity configuration signals configuring a functional operation of the MSS entity.

In a fifty-fifth aspect, alone or in combination with one or more of the fifty-first aspect through the fifty-fourth aspect, wherein the MSS entity configuration signals includes reporting parameters that configure a reporting operation of the MSS entity to the network entity.

In a fifty-sixth aspect, alone or in combination with one or more of the fifty-first aspect through the fifty-fifth aspect, wherein the MSS data includes capability data of the MSS entity.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a network entity, the method comprising:
transmitting operational control signals to one or more multimedia, security, surveillance (MSS) entities via an MSS interface of the network entity, the MSS interface configured to transmit the operational control signals in a communication protocol compatible with a first radio access technology (RAT) of the one or more MSS entities, the communication protocol being incompatible with a second RAT of the network entity, the first RAT being different from the second RAT; and
receiving MSS data from at least one MSS entity of the one or more of the MSS entities via the MSS interface.

2. The method of claim 1, wherein the MSS interface includes one of:
a network MSS interface, the operational control signals transmitted via the MSS interface including network MSS interface protocol signals compatible with the one or more MSS entities; or
an enhanced positioning protocol interface, the operational control signals including enhanced positioning protocol signals that encapsulate the network MSS interface protocol signals compatible with the one or more MSS entities.

3. The method of claim 2, further including:
transmitting a discovery broadcast message using the MSS interface; and
receiving a registration signal from the one or more MSS entities.

4. The method of claim 2, further including:
receiving a registration request from the one or more MSS entities; and
transmitting a registration signal to the one or more MSS entities in response to the registration request.

5. The method of claim 2, wherein the operational control signals include MSS entity configuration signals configuring a functional operation of the one or more MSS entities.

6. The method of claim 5, wherein the MSS entity configuration signals includes reporting parameters that configure a reporting operation of the one or more MSS entities to the network entity.

7. The method of claim 2, wherein the transmitting the operational control signals includes:
identifying a target group of MSS entities from the one or more MSS entities, wherein the target group of MSS entities includes each MSS entity of the one or more MSS entities satisfying a predefined criteria; and
broadcasting the operational control signals to the target group of MSS entities via the MSS interface.

8. The method of claim 2, wherein the MSS data includes capability data of
a corresponding MSS entity of the one or more MSS entities from which the MSS data is received.

9. A method of wireless communication performed by a multimedia, security, surveillance (MSS) entity, the method comprising:
receiving operational control signals from a network entity via a MSS interface, the operational control signals received in a communication protocol compatible with a first radio access technology (RAT) of the MSS entity, the communication protocol being incompatible with a second RAT of the network entity, the first RAT being different from the second RAT; and
transmitting MSS data to the network entity via the MSS interface using the communication protocol compatible with the MSS entity.

10. The method of claim 9, further including:
receiving a discovery broadcast message from the network entity, the discovery broadcast message received in the communication protocol compatible with the MSS entity; and
transmitting a registration signal to the network entity in response to the discovery broadcast message, the registration signal transmitted in the communication protocol compatible with the MSS entity.

11. The method of claim 9, wherein the establishing the communication includes further including:
transmitting a registration request to the network entity, the registration request transmitted in the communication protocol compatible with the MSS entity; and
receiving a registration signal from the network entity, the registration signal received in the communication protocol compatible with the MSS entity.

12. The method of claim 9, wherein the operational control signals include MSS entity configuration signals configuring a functional operation of the MSS entity.

13. The method of claim 12, wherein the MSS entity configuration signals includes reporting parameters that configure a reporting operation of the MSS entity to the network entity.

14. The method of claim 9, wherein the MSS data includes capability data of the MSS entity.

15. A network entity comprising:
a memory storing processor-readable code; and
at least one processor coupled to the memory, the at least one processor configured to execute the processor-readable code to cause the at least one processor to:
transmit operational control signals to one or more multimedia, security, surveillance (MSS) MSS entities via an MSS interface of the network entity, the MSS interface configured to transmit the operational control signals in a communication protocol compatible with a first radio access technology (RAT) of the one or more MSS entities, the communication protocol being incompatible with a second RAT of the network entity, the first RAT being different from the second RAT; and
receive MSS data from at least one MSS entity of the one or more of the MSS entities via the MSS interface.

16. The network entity of claim 15, wherein the MSS interface includes one of:
a network MSS interface, the operational control signals transmitted via the MSS interface including network MSS interface protocol signals compatible with the one or more MSS entities; or
an enhanced positioning protocol interface, the operational control signals including enhanced positioning protocol signals that encapsulate the network MSS interface protocol signals compatible with the one or more MSS entities.

17. The network entity of claim 16, wherein the configuration of the at least one processor further includes configuration to:
transmit a discovery broadcast message using the MSS interface; and
receive a registration signal from the one or more MSS entities.

18. The network entity of claim 16, wherein the configuration of the at least one processor further includes configuration to:
receive a registration request from the one or more MSS entities; and
transmit a registration signal to the one or more MSS entities in response to the registration request.

19. The network entity of claim 16, wherein the operational control signals include MSS entity configuration signals configuring a functional operation of the one or more MSS entities.

20. The network entity of claim 19, wherein the MSS entity configuration signals includes reporting parameters that configure a reporting operation of the one or more MSS entities to the network entity.

21. The network entity of claim 16, wherein the configuration of the at least one processor to transmit the operational control signals includes configuration of the at least one processor to:
identify a target group of MSS entities from the one or more MSS entities, wherein the target group of MSS entities includes each MSS entity of the one or more MSS entities satisfying a predefined criteria; and
broadcast the operational control signals to the target group of MSS entities via the MSS interface.

22. The network entity of claim 16, wherein the MSS data includes capability data of a corresponding MSS entity of the one or more MSS entities from which the MSS data is received.

23. A multimedia, security, surveillance (MSS) entity comprising:
a memory storing processor-readable code; and
at least one processor coupled to the memory, the at least one processor configured to execute the processor-readable code to cause the at least one processor to:
receiving operational control signals from a network entity via a MSS interface, the operational control signals received in a communication protocol compatible with a first radio access technology (RAT) of the MSS entity, the communication protocol being incompatible with a second RAT of of the network entity, the first RAT being different from the second RAT; and
transmitting MSS data to the network entity via the MSS interface using the communication protocol compatible with the MSS entity.

24. The MSS entity of claim 23, wherein the configuration of the at least one processor further includes configuration to:
receive a discovery broadcast message from the network entity, the discovery broadcast message received in the communication protocol compatible with the MSS entity; and
transmit a registration signal to the network entity in response to the discovery broadcast message, the registration signal transmitted in the communication protocol compatible with the MSS entity.

25. The MSS entity of claim 23, wherein the configuration of the at least one processor further includes configuration to:
transmit a registration request to the network entity, the registration request transmitted in the communication protocol compatible with the MSS entity; and
receive a registration signal from the network entity, the registration signal received in the communication protocol compatible with the MSS entity.

26. The MSS entity of claim 23, wherein the operational control signals include MSS entity configuration signals configuring a functional operation of the MSS entity.

27. The MSS entity of claim 26, wherein the MSS entity configuration signals includes reporting parameters that configure a reporting operation of the MSS entity to the network entity.

28. The MSS entity of claim 23, wherein the MSS data includes capability data of the MSS entity.
